(19) United States
(12) Patent Application Publication
(10) Pub. No.: US 2012/0047568 A1
(43) Pub. Date: Feb. 23, 2012

(54) Digital Asset Management on the Internet

(75) Inventor: Steven Keng, Cupertino, CA (US)

(73) Assignee: MyWeboo Inc., Cupertino, CA (US)

(21) Appl. No.: 12/858,410

(22) Filed: Aug. 17, 2010

(51) Int. Cl. G06F 9/46; G06F 15/16; G06F 17/30; G06F 21/00; G06F 3/01

(52) U.S. Cl. 726/9; 719/328; 707/769; 707/802; 707/E17.014; 707/E17.044; 715/733

(57) ABSTRACT

Techniques pertaining to managing digital assets and data stored in various third-party web services on the Internet are disclosed. A web platform based on web standards is constructed. A web driver containing specifications of a plurality of digital asset management feature plug-ins is provided. A third-party web service on the Internet implements the web driver by adding programming codes according to the specifications and returns the implemented web driver. The web platform registers the third-party web service by storing the web driver in a database. Any registered web services can be added to the web platform as virtual storage devices, or Smart Drives, by a user. Digital assets and data stored in various registered third-party web services can be directly managed or ported from one to the others through accessing corresponding Smart Drives without having to go through multiple logins.

### BACKGROUND OF THE INVENTION

1. Field of the Invention

The present invention generally relates to the area of digital information storage management, and more particularly, relates to managing various types of digital assets stored in different web platforms and social networks on the Internet.

2. Description of Related Art

In today's digital computing age, people store information, data and documents in digital forms on various storage devices. For example, a hard-disk drive in a computer system. Retrieving and managing the digital information is straight forward and simple when the information is stored locally on an individual computer system.

However, as access to the Internet becomes a norm in daily life, and as people communicate through the Internet more frequently than ever before, digital information management and storage expands further, beyond local machines or local area networks to websites on the Internet. A user may store various types of digital assets on different websites. For example, a user may utilize a website that provides special photo services to store their digital pictures, or a commercial website to store business transactions and client information. Furthermore, a user may also join social network websites (e.g. Facebook™), where the user's personal information and profile can be stored, and also subscribe to on-line storage website services (e.g., Amazon S3) to increase storage space for their digital data. Over time, the number of these websites has multiplied and the stored personal data and digital assets are scattered in different website locations, and handling them becomes cumbersome. When data updates are needed, e.g., to a personal profile, the user is required to access each website separately to make the changes. This process is inefficient, inconvenient and susceptible to errors.

Depending on the website service, a user may only be allowed to store digital assets of certain formats onto a particular site. For example, a photo website may only allow image files and not text documents to be stored. Transferring and manipulating digital assets between websites is not as straight forward as moving files between the drives of a computer system. Websites provide specific application programming interfaces (APIs) which allows end users to access services on their websites. The APIs for different websites may contain different specifications for data structures. This limits the types of data that can be directly exchanged between websites.

Internet users also consume a lot of digital data by accessing information on websites such as browsing news websites, reading articles and blogs, etc. The information is accessed through uniform resource locator (URL) links. These links provide the user a more convenient way to revisit the websites in the future and may also be collected in the form of bookmarks. Over a period of time, the numbers of links amassed become vast and hard to manage.

As the Web continues to evolve, the amount of information and data used and consumed by Internet users increases. An individual's digital assets stored in various sources on the Internet grow and become scattered across many websites. Users have to login to one website to access a piece of information and login to another website for a different piece of information, which is inconvenient and inefficient. Thus, there is a need and desire to consolidate the information stored in various sources on the Internet.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

According to one aspect of the invention, a web platform based on web standards is constructed in one or more computer systems, for example, a web server, for managing digital assets stored on various websites. A web driver containing specifications of a plurality of digital asset management feature plug-ins is provided. Each feature plug-in contains a plurality of functions for achieving specific operations, for example, renaming a file. A third-party web service on the Internet implements the web driver by adding programming codes for the functions according to the specifications and returns the implemented web driver. The web platform registers the third-party web service by generating an ID for the web driver and storing the web driver in a web driver database. Names and/or icons of the registered third-party web service are populated on a web desktop user interface in the web platform. Any registered third-party web service can be added by a user of the web platform as a virtual storage device, a Smart Drive.

Once added, the Smart Drives function as if they were directly coupled storage devices regardless of their data type and location. For example, Smart Drives can be music web services on the internet, social networks web services, or storage devices in computer systems. The owner or user is able to port data from one third-party web service to other third-party web services without having to go through multiple logins.

When a user selects a Smart Drive from the web desktop user interface, the web platform searches the unique ID of the corresponding web driver in the web driver database, then loads and executes the web driver. To access and manage digital assets and data stored in the selected Smart Drive, the user initiates action requests through the web desktop user interface and the APIs provided by the web platform. The web driver translates the action requests into the third-party web service's specific APIs and sends requests to the corresponding third-party website service. Results from the action are then returned through the web driver and processed for displaying on the Web Desktop user interface or on the user's browser.

According to one embodiment, the present invention is a method for digital asset management on the Internet comprising: constructing a web platform based on web standards; providing through the web platform a web driver containing specifications of a plurality of digital asset management feature plug-ins; registering a third-party web service in the web platform by storing the web driver, which has been implemented by the third-party web service according to the specifications, in a database; adding the registered third-party web service as a virtual storage device, i.e., a Smart Drive, to the web platform by retrieving and executing the web driver stored in the database; and managing digital assets stored in the registered third-party web service by selecting the Smart Drive and issuing commands through a web desktop user interface and an API layer in the web platform.

According to another embodiment, the present invention is web platform for digital asset management on the Internet comprising: a web desktop user interface for displaying user data and issuing action requests; an application programming interface (API) layer for providing a programmatic gateway for the action requests; a request controller for accepting the action requests from the API layer; a data manager for providing data for the request controller, wherein the data manager comprises a user data manager and a web driver manager to store user data and a plurality of web drivers for web services; and a data processor for processing results from requested actions for displaying on the web desktop user interface or a user web browser.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A is a schematic function block diagram of a Smart Drive Web Platform (SDWP);

FIG. 1B is a schematic block diagram showing the contents of an exemplary user data manager in the SDWP according to one embodiment of the invention;

FIG. 1C is a schematic block diagram showing the contents of an exemplary web driver manager in the SDWP according to one embodiment of the invention;

FIG. 2A is block diagram showing the contents of a web driver according to one embodiment of the invention;

FIG. 2B is an example showing a specification and implemented programming code for a feature plug-in function of a web driver;

FIG. 3 is a flowchart showing a process of registering a third-party web service in the SDWP according to one embodiment of the invention;

FIG. 4 is a flowchart showing a process of adding a registered third-party web service as a Smart Drive in the SDWP according to one embodiment of the invention;

FIG. 5A is a block diagram showing a process of accessing a Smart Drive in the SDWP according to one embodiment of the invention;

FIG. 5B shows the processes in the SDWP when a user accesses and issues commands to manage digital assets stored in a third-party web service;

FIG. 6 shows an exemplary collection of Smart Drives presented on the Web Desktop user interface of the SDWP;

FIG. 7 shows some exemplary digital asset and data management features provided in the SDWP according to one embodiment of the invention; and

FIG. 8 is a functional diagram depicting an exemplary computer system used for implementing the invention according to one embodiment of the invention.

### DETAILED DESCRIPTION OF THE INVENTION

The detailed description of the invention is presented largely in terms of procedures, steps, logic blocks, processing, and other symbolic representations that directly or indirectly resemble the operations of a web platform that allows a user to manage digital assets stored in various third-part web services on the Internet. These process descriptions and representations are typically used by those skilled in the art to most effectively convey the substance of their work to others skilled in the art.

Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

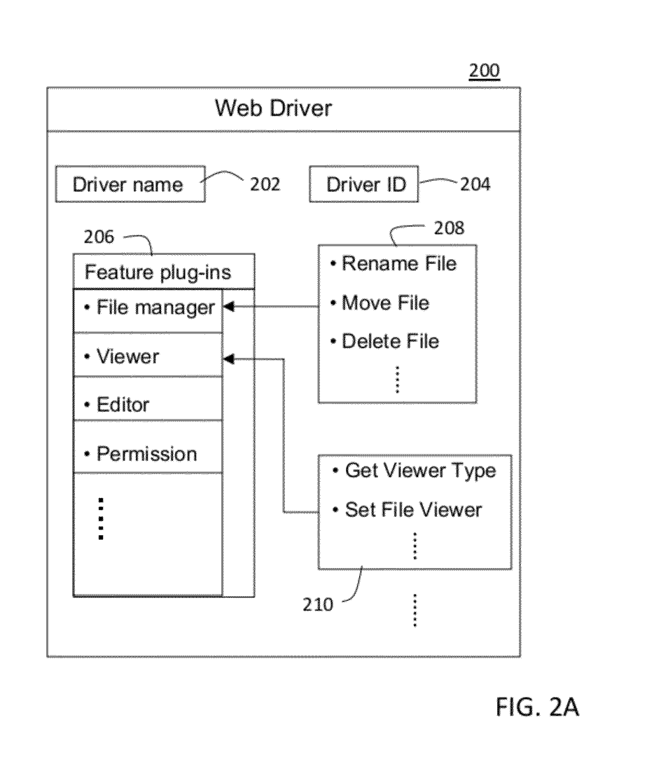

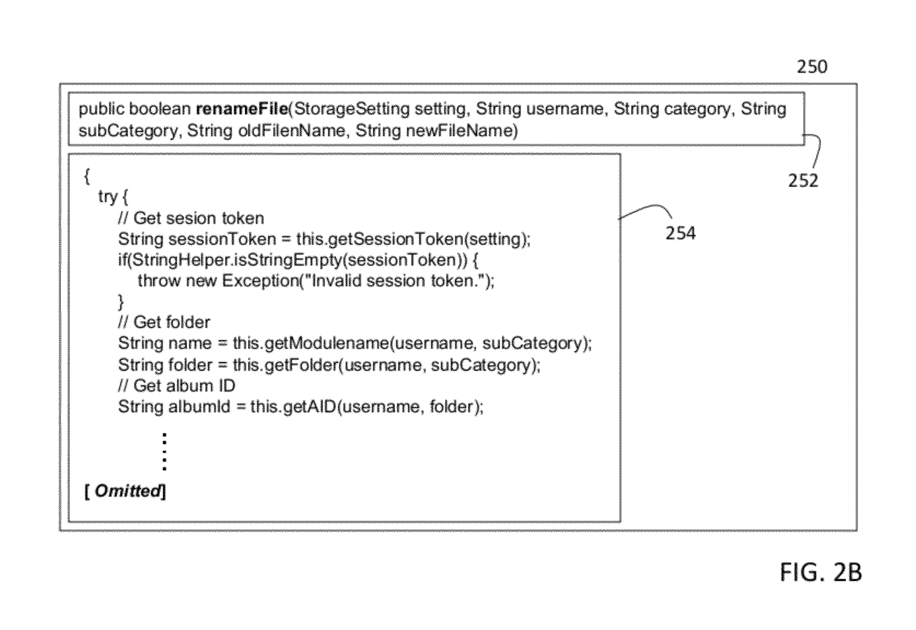

To manage the scattered digital assets and data stored on various third-party websites, or web servers, and to make them more accessible to a user, a web platform based on web standards is constructed. To distinguish this particular web platform from other websites' platforms, we will call it “Smart Drive Web Platform” (SDWP) hereinafter. Websites or web servers providing various services, hereinafter “third-party web services”, to be managed by a user are “mapped” to the SDWP as virtual storage devices or drives—we will call these drives “Smart Drives” hereinafter. Each third-party web service is required to be “registered” in the SDWP before it can be mapped as a Smart Drive. The registration of a third-party web service is by implementing programming codes to a corresponding web driver. A web driver communicates with a third-party web service on the Internet. The web driver and its implementation will be discussed in detail later in FIGS. 2A and 2B.

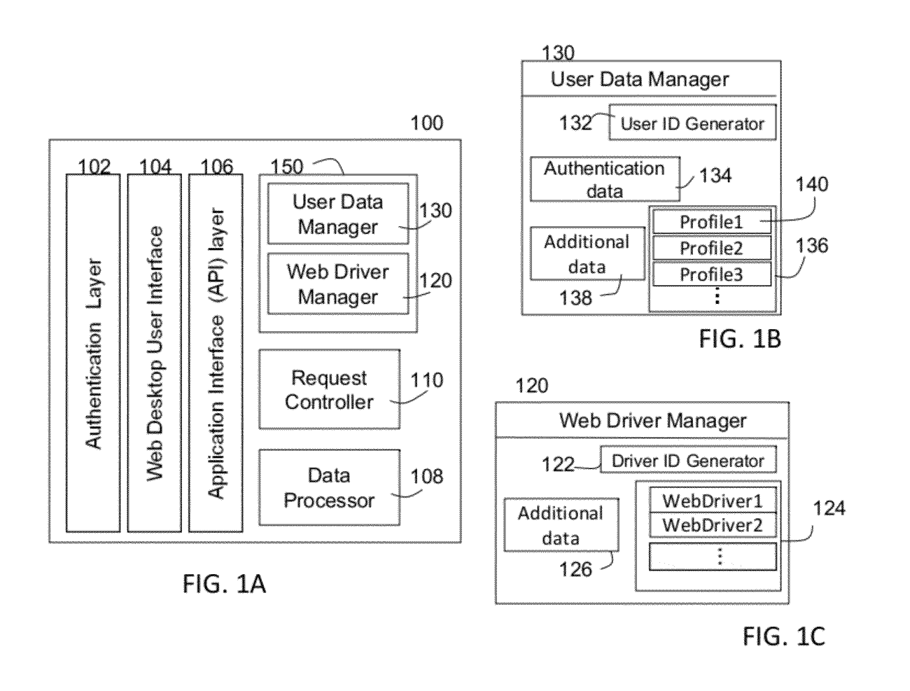

FIG. 1A is a schematic function block diagram of the Smart Drive Web Platform (SDWP). Built on top of web standards, according to one embodiment, the SDWP contains an authentication layer 102 for verifying the authenticity of a user; a user interface (hereinafter, Web Desktop user interface) 104 for the user to interact with the SDWP 100; and an application programming interface (API) layer 106 to provide a programmatic gateway to accept requests, e.g., http (hypertext transfer protocol), from the web desktop user interface 104. The web desktop user interface 104 is a graphic user interface, in which links to files or programs are shown as icons or names. These links in the web desktop user interface provide a convenient way for a user to execute commands or access stored files. According to one embodiment, Smart Drives corresponding to third-party web services are presented on the web desktop user interface 104. The SDWP also contains a request controller 110 to receive action requests from the API layer 106 and to maintain a flow of each request; a data manager 150 containing a user data manager 120 for storing user data for each individual user and a web driver manager 130 for storing the web drivers; and a data processor 108 for generating http response for the results from the requested actions. The request controller 110 contains programming codes to perform search on the data stored in the data manager 150 and keep command requests in order.

Contained in the user data manager 120, as shown in FIG. 1B, is a user ID generator 132 for generating a unique user ID for each user permitted to access the SDWP; an area to store authentication data 134; a user profile database 136; and an area for store additional data 138. Each user profile 140 in the user profile database 136 represents a Smart Drive, which the user has added to the SDWP. FIG. 1C is a block diagram showing the details of the web driver manager 120. The web driver manager 120 contains a web driver ID generator 122 for generating a unique ID for each web driver implemented for a third-party web service; a web driver database 124 to store the implemented web drivers; and an area for storing additional data 126, e.g., name and icon of the web drivers.

Before a user is allowed to directly access digital assets stored in third-party web services through the SDWP, a web driver containing specifications of a plurality of digital assets and data management feature plug-ins is provided for the third-party web services to implement programming codes. Referring to FIG. 2A, the web driver 200 contains a driver name field 202; a Driver ID field 204; and a group of digital asset management feature plug-ins 206. Each feature plug-in contains a plurality of functions for achieving specific operations for that feature. In this example, a File Manager feature plug-in has a group of related functions 208 including “Rename File”, Move File”, “Delete File”, etc., and a Viewer plug-in has a group of related functions 210 including “Get Viewer Type”, “Set File Viewer”, etc. To avoid lengthy repetition and obscuring the gist of the invention, functions for other feature plug-ins are omitted here. Because each third-party web service's platform contains specific application programming interfaces (APIs) for a user to carry out specific operations, any requests from a user to access the digital assets and data stored in a particular third-party web service are required to be in acceptable formats and recognizable by the third-party web service. The web driver 200 provides a unified programming template where specifications for programming each of the feature plug-ins are specified. By implementing the web driver with specific programming codes, which meet the SDWP feature plug-in specifications and the specifications required by a third-party web service platform, the implemented web driver serves as a translator between the SDWP and the web service. A user is, therefore, able to access a web service directly from the SDWP.

To facilitate the understanding of the implementation of a web driver, an example is illustrated in FIG. 2B. A specification 252 for “renameFile” function is provided in the web driver. Programming code 254 for achieving the “renameFile” operation in a particular third-party web service platform, (e.g., Picasa™) is added, or implemented, to the web driver according to the specification 252. Because the programming code 254 needs to meet the third-party web service's requirements, the code implementation is usually carried out by the web service. The implemented web driver 250 can be called when a user wants to carry out “renameFile” function in that particular third-party web service. Depending on the features the third-party web services provides, the implemented web drivers may contain different feature plug-ins for different third-party web services.

After implemented with programming code from a third-party web service, the web driver is returned to the SDWP where the driver ID generator 122 generates a unique web driver ID for the web driver. The implemented web driver and the unique ID are then stored in the web driver database 126. The web driver ID is also stored in the driver ID field 204 in the web driver. If a name of the web driver is provided, the name is also stored in the web driver in the driver name field 202. The third-party web service corresponding to the implemented web driver is now registered in the SDWP, and can be added as a virtual storage device, or Smart Drive, by a SDWP user.

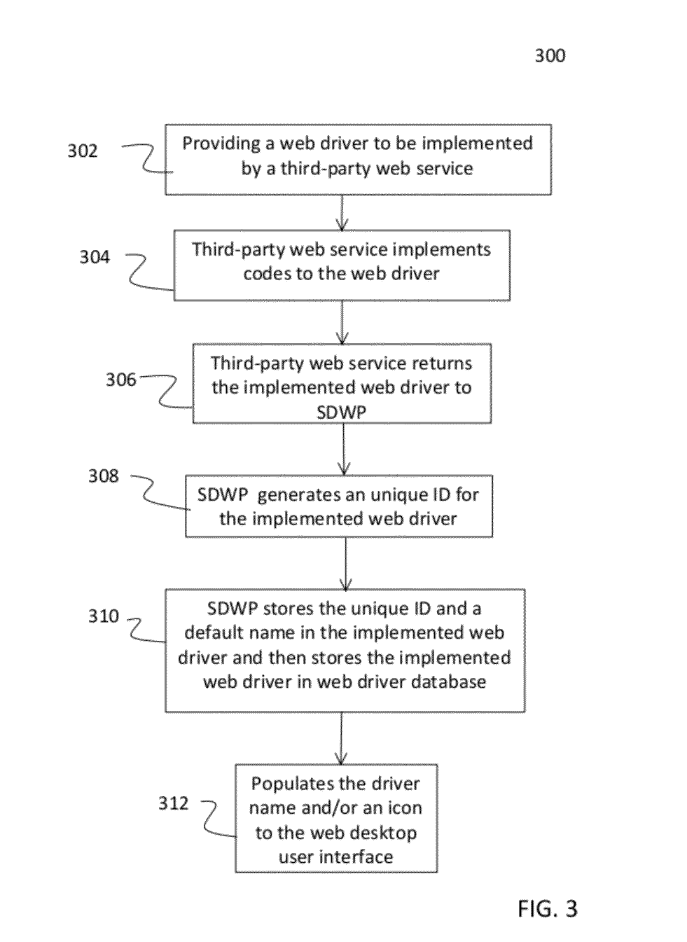

FIG. 3 is a block diagram showing the details of registering a web service in the SDWP. At 302 a web driver is provided for any third-party web services to implement. According to one embodiment, the web driver to be implemented can be sent by the SDWP to the third-party web services. The web driver contains a group of feature plug-ins for digital asset and data management and the specifications for coding the features and the functions related to each plug-in. At 304, a third-party web service implements the web driver with necessary programming codes that meet both the third-party web service's platform requirements and the SDWP specifications contained in the web driver. At 306, the third-party web service notifies the SDWP that programming codes have been implemented in the web driver and sends the implemented web driver to the SDWP. After receiving the implemented web driver from the third-party web service, at 308, the ID generator 122 in the web driver manager 120 generates a unique web driver identification (ID) for the implemented web driver. At 310, SDWP stores the unique web driver ID and a default web driver name in the implemented web driver, and, at 312, stores the implemented web driver in the web driver database 124. Additionally, other attributes related to the implemented web driver, for example, an icon, are stored in the additional data area 126. Each implemented web driver is identified by its unique web driver ID. At 312, the default driver name, and/or the icon, is populated to the web desktop user interface 104 The third-party web service is now “registered” in the SDWP. The registered third-party web service can now be mapped, or added, to the SDWP.

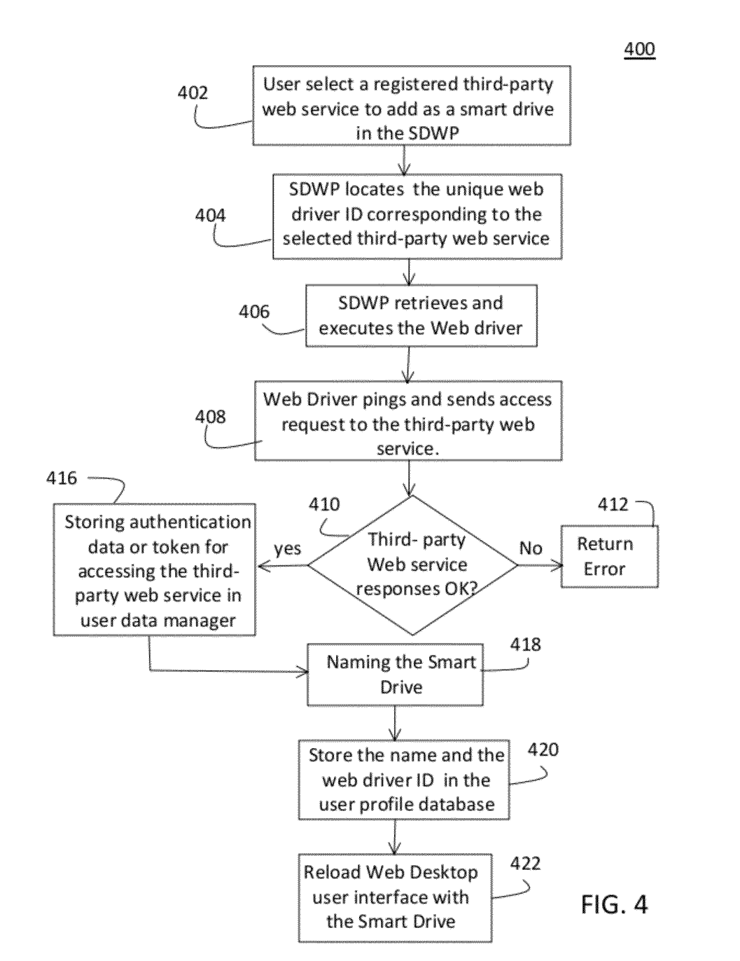

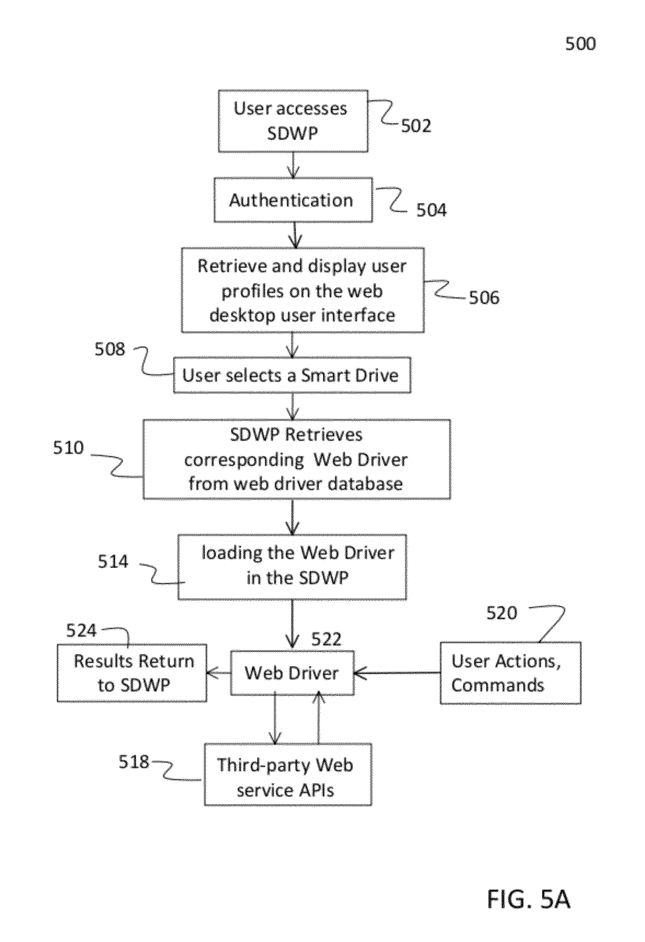

Before accessing the digital assets and data stored in a registered third-party web service through the SDWP, a user needs to add the registered web service as a virtual storage device, Smart Drive, in the SDWP. FIG. 4 is a block diagram showing a process of adding a registered third-party web service as a Smart Drive in the SDWP according to one embodiment of the invention. At 402, a user selects a registered third-party web service from the web desktop user interface 104 to add as a Smart Drive. At 404, the control request 110 in the SDWP searches the web driver database 124 and locates the unique ID corresponding to the selected registered third-party web service and, at 406, retrieves and executes the corresponding web driver. At 408, the web driver pings and sends access request to the third-party website service. The user is prompted to obtain authorization and permission from the third-party website service, e.g., login with user ID and password. At 410, the third-party website service platform verifies the user's authentication and other security requirements, and responds to the SDWP with either an acceptance (yes) or a rejection (no) of the user's request to access the third-party web service. If a rejection (no) is returned, at 412, the SDWP posts error to notify the user of failure to add a Smart Drive; if an acceptance is returned, at 416, the authentication data or the authorization token (e.g., Oauth token) for accessing the third-party web service is stored in the authentication data area 134 in the user data manager 130. At 418, a default web driver name is used, or the user is prompt to enter a new name, for the Smart Drive. If a new name is entered, at 420, the SDWP replaces the default web driver name in the web driver with the new name. The Smart Drive name and the corresponding web driver ID are stored into the user profile database 136. The user may change the name of a Smart Drive to any preferred name through the web desktop user interface 104 at any time after the Smart Drive is added. At 422, the web desktop user interface 104 is reloaded to display the name of the newly added Smart Drive. If an icon for the third-party web service is available, e.g., stored in the additional data area 126, the icon is also displayed along with the name of the web service.

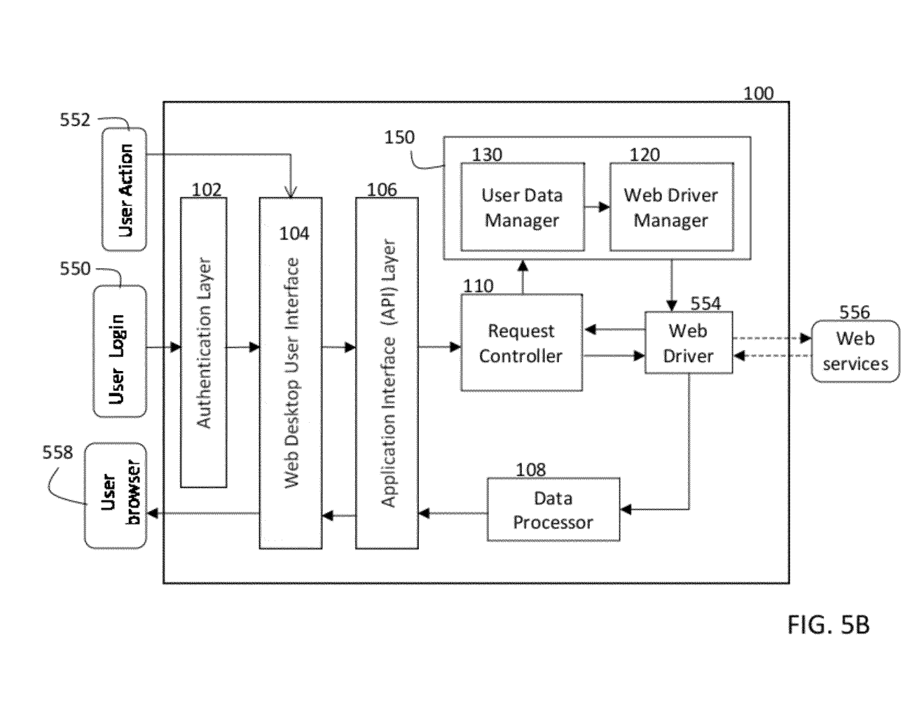

Once a Smart Drive is added, a user can access the Smart Drive directly from the Web Desktop user interface 104 without the need to login and go through the authentication verification in the corresponding website each time. The Smart Drive corresponding to the third-party web service is analogous to a storage drive directly coupled to the user's computer system. The user can manage the digital assets and data stored in the third-party web service directly from the Smart Drive through the web desktop user interface and the APIs provided in the SDWP. FIG. 5A illustrates an exemplary basic process of accessing a Smart Drive. At 502, when accesses the SDWP (e.g. login), a user is required to input SDWP authentication information at 504, e.g., user name and password. The SDWP verifies the user authentication and, at 506, retrieves user profiles 136 from the user data manager 130 according to the user ID, and displays the stored profiles 136 on the web desktop user interface. The user profiles contain information, including the web driver ID, about the Smart Drives, which have been added by the user previously. The user is now successfully logged on to the SDWP and may select any of the many Smart Drives displayed on the web desktop user interface 104. At 508, as the user selects a Smart Drive, the SDWP retrieves the selected Smart Drive and the unique web driver ID corresponding to the selected Smart Drive at 510. The web driver is then loaded and executed, at 514. Once the web driver is installed, the Smart Drive is now ready to be accessed by the user. At 520, when the user issues a command (e.g. editing a data file) through the web desktop user interface and the API layer from the SDWP to activate operations provided by the third-party web service's APIs, at 518, the loaded web driver at 522 relays the action commands to the third-party web service and transforms the results of the action returned from the third-party web service into a file structure understood by the SDWP and return the results to the user at 524.

FIG. 5B shows the processes in the SDWP 100 when a user accesses and issues command to manage digital assets stored in a web service. As a user logs in at 550 to the SDWP, the authentication layer 102 verifies the user's authentication information, e.g., user name and password. After a successful login, the web desktop user interface 104 displays user profiles according to the user data stored in the user data manager 130. When the user initiates an action at 552 through the web desktop user interface, for example, rename a file in a third-party web service, API layer 106 sends the action request to the request controller 110. The request controller 110 searches the unique web driver ID corresponding to the Smart Drive in the user data manager 130 and locates the web driver corresponding to the unique web driver ID in the web driver manager 120. The web driver is called and executed, or installed, at 554. The request controller 110 sends the action request through the web driver to the third-party web service 556 on the Internet. The third-party web service completes the action request and returns the results, e.g., rename a file, the web driver at 554 converts the results from the third-party web service to a file structure that is understood by the SDWP. The converted results are passed to the data processor 108 for necessary data processing to display on the web desktop user interface 104, or on a user's browser 558.

For storage devices a user has direct access, e.g., hard-disk drives directly coupled to the computer system, the SDWP allows the user to add the storage devices as Smart Drives without the need of implementing a web driver.

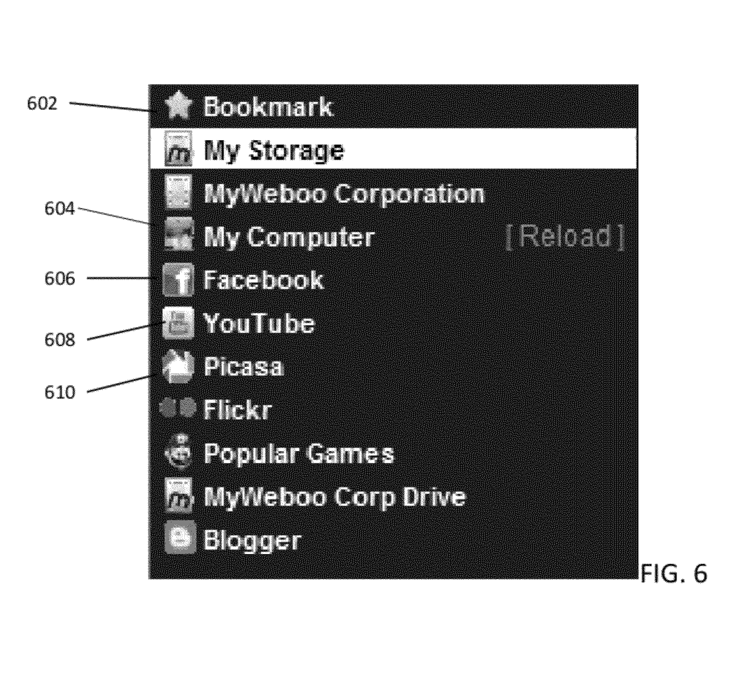

FIG. 6 shows an exemplary collection of Smart Drives presented on the web desktop user interface of the SDWP. The Smart Drives can be a collection of files of any types of data format. In fact, any file systems on a traditional computer system or any digital assets on a web service that can be transformed into a file structure through web-based APIs can be registered and added as a Smart Drive in the SDWP. Referring to FIG. 6, Smart Drives in various types of data formats are shown with their respective icons and names. For example, Smart Drive 602 is a collection of Bookmarks; Smart Drive 604 contains local files or data; Smart Drive 606 is related to a social network and may contain personal profiles; Smart Drive 608 is related to a video web service and contains video format digital assets; and Smart Drive 610 is an image storage web service. When a user selects a Smart Drive, e.g., clicks on the icon or the name, the SDWP calls and executes the web driver corresponding to the Smart Drive and establishes a directly communication with the third-party web service corresponding to that particular Smart Drive. Because the necessary authentication and permission processes have been included in the web driver when the user adds the Smart Drive to the SDWP, there is no need to login for accessing the third-party web service every time. Through the web desktop user interface and the API layer provided by the SDWP, the user is able to directly manage the digital assets stored in the third-party web service.

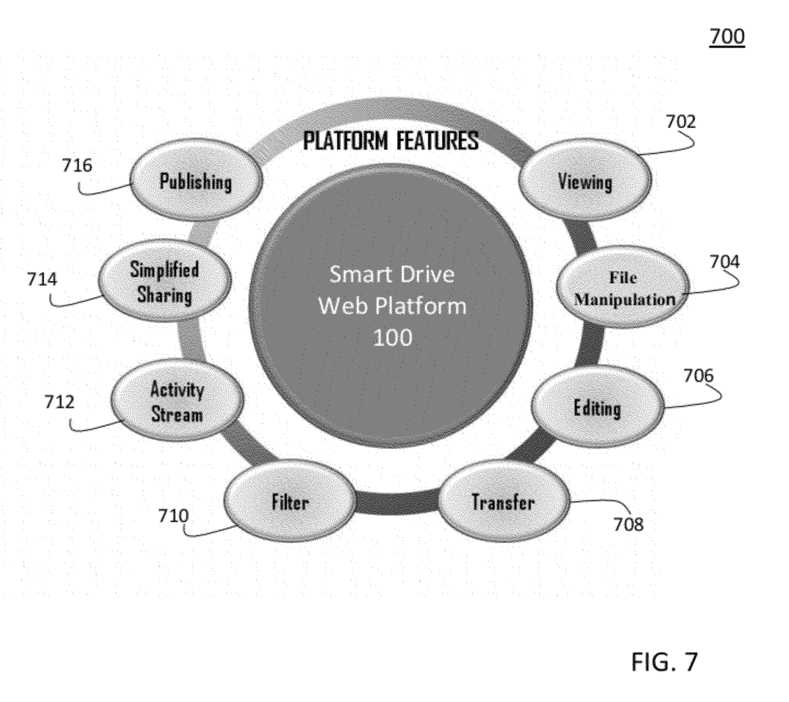

The SDWP provides various features for manage digital assets and data stored in various third-party web services on the Internet. For example, features for viewing, uploading, and downloading video clips are provided for third-party websites providing services associated with video digital assets. Shown in FIG. 7 are a number of exemplary features provided by the SDWP for managing personal digital assets. Other features may be added as necessary. It should be noted that the features discussed herein are for illustration purpose and should not be view as a limitation to the scope of the invention.

A “viewing” feature 702 determines the type of data or contents of a file, and calls an appropriate viewing module in the SDWP to open the file or data accordingly. Each type of file or data has a processing module.

A “file manipulation” feature 704 is called when a user uses drag-and-drop to rearrange the ordering of file or data on the Web Desktop. The file manipulation API 704 first determines the type of the Smart Drive. If the Smart drive is local computer storage, the file manipulation feature 704 moves the files according to the operations of the file system of the computer; if the Smart Drive is a web service, the web service's API is called to process and manipulate the data structure.

An “Editing” feature 706 first determines the type of data or contents of a file, then returns an appropriate editing module to edit the data or file. The “Editing” feature 706 also locks the selected data or file from being accessed by other actions until the editing is completed and the data or file is released. While the specific file or data is locked, no further editing can be executed.

A “Transferring” feature 708 exports files from one Smart Drive to another. Users are given the ability to drag folders or files from one Smart Drives and drop them into another Smart Drive. The action automatically creates a copy of the files being dragged into the destination folder. Each Web driver implements a “transfer/export” functions that takes a folder/file path as an input and a zipped file of the given folder/file as an output.

A “Filtering” feature 710 is used to filter data, folders, and files by tags generated by a user. Only the data, file, and folder that match the filter criteria are presented.

An “Activity Stream” feature 712 provides an instant communication channel to send activity streams with specific number of characters per message. Public sharing allows users that have access to the driver to gain access to the activity stream. The activity stream is updated through human interactions, e.g. typing a message.

A “Sharing” feature 714 creates a public URL for all public data, folder, file, and Smart Drives. The public URL is used by other people to access data or files stored in the specific resource that the owner wants to release for sharing.

A “Publishing” feature 716 is another core function that a web driver can implement. Upon publishing a file or a folder, a public URL (uniform resource locator) is created and published through a handful of social networks including Facebook™ Twitter™, Stumbleupon, and etc.

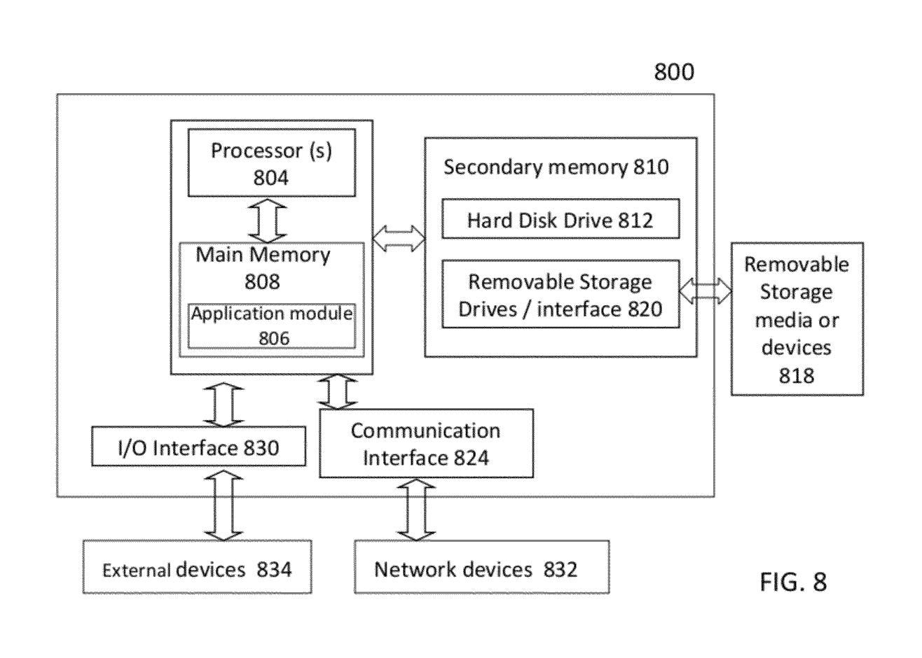

According to one embodiment, the present invention is directed towards one or more computer systems capable of carrying out the operations described herein. An example of a computer system 800 is shown in FIG. 8. The computer system 800 includes one or more processors 804, an internal main memory 808 and a secondary memory 810. The secondary memory 810 may include, for example, one or more hard disk drives 812 and/or removable storage drives/interface 820, which reads from and/or writes to a removable storage media or devices 818 in a well-known manner.

Computer system 800 includes a communications interface 824 to communicate with external network devices 832. The communications interface 824 allows software and data to be transferred between the computer system 800 and other external communication devices, such as a modem, a network interface, etc.

The computer system 800 also includes an input/output (I/O) interface 830, through which the computer system 800 communicates with external devices, such as a monitor, a printer etc. Computer codes are stored as application module 806 in main memory 808 and/or secondary memory 810. Computer codes may also be received via communications interface 824. Such computer codes, when executed, enable the computer system 800 to perform the operations of the present invention as discussed herein.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claim. Accordingly, the scope of the present invention is defined by the appended claims rather than the forgoing description of embodiments.

What is claimed is:

1. A method for digital asset management on the Internet, the method comprising:
constructing a web platform based on web standards;
providing through the web platform a web driver containing specifications of a plurality of digital asset management feature plug-ins;
registering a third-party web service in the web platform by storing the web driver, which has been implemented by the third-party web service according to the specifications, in a database;
adding the registered third-party web service as a virtual storage device, i.e., a Smart Drive, to the web platform by retrieving and executing the web driver stored in the database; and
managing digital assets stored in the registered third-party web service by selecting the Smart Drive and issuing commands through a web desktop user interface and an API layer in the web platform.

2. The method according to claim 1, wherein registering the third-party web service further comprises generating a unique web driver ID and storing the unique ID in the web driver and in a user data manager.

3. The method according to claim 2, wherein adding the Smart Drive to the web platform further comprises retrieving the unique web driver ID from the user data manager and locating the web driver in the database.

4. The method according to claim 2, wherein registering the third-party web service to the web platform further comprises storing a name and an icon corresponding to the web driver to the database.

5. The method according to claim 4, wherein adding the Smart Drive to the web platform further comprises displaying the icon and the name corresponding to the web driver on the web desktop user interface.

6. The method according to claim 1, wherein adding the Smart Drive to the web platform further comprises:
prompting a user to login the register web service;
receiving a user authentication data or authentication token from the third-party web service; and
storing the user authentication data or token in the user data manager.

7. The method according to claim 1, wherein the issuing commands comprises issuing digital asset management commands of: file manipulating, viewing, transferring, editing, filtering, simple sharing, publishing and activity streaming.

8. The method according to claim 1, wherein providing the web driver further comprises:
sending the web driver to third-party web services; and
receiving the implemented web driver from the third-party web services.

9. A web platform for digital asset management on the Internet, the web platform comprising:
a web desktop user interface for displaying user data and issuing action requests;
an application programming interface (API) layer for providing a programmatic gateway for the action requests;
a request controller for accepting the action requests from the API layer;
a data manager for providing data for the request controller, the data manager comprises a user data manager to store user data, and a web driver manager to store a plurality of web drivers; and
a data processor for processing results from requested actions for displaying on the web desktop user interface or a user web browser.

10. The web platform according to claim 9, wherein the user data manager comprises:
a user ID generator for generating an ID for each web platform user;
an authentication data area for storing user authentication data or authentication tokens from third-party web services; and
a user profile database for storing user added third-party web services.

11. The web platform according to claim 9, wherein the web driver manager comprises:
a web driver ID generator for generating a unique web driver ID for each web driver; and
a web driver database for storing web drivers and the unique web driver IDs.

12. The web platform according to claim 11, wherein the web driver database further comprises a name field for storing names and icons of the web driver.

13. The web platform according to claim 9, wherein each of the plurality of web drivers comprises digital asset management feature plug-ins.

14. The web platform according to claim 13, wherein the digital asset management feature plug-ins comprises: file manipulating, viewing, transferring, editing, filtering, simple sharing, publishing and activity streaming.

15. The web platform according to claim 9 further comprising an authentication layer for verifying user's authentication.

16. A system for digital asset management on the Internet comprising:
a memory for storing computer readable code for managing digital assets on the Internet;
at least one processor coupled to the memory, the at least one processor executing the computer readable code in the memory to perform operations of:
constructing a web platform based on web standards;
providing through the web platform a web driver containing specifications of a plurality of digital asset management feature plug-ins;
registering a third-party web service in the web platform by storing the web driver, which has been implemented by the third-party web service according to the specifications, in a database;
adding the registered third-party web service as a virtual storage device, i.e., a Smart Drive, to the web platform by retrieving and executing the web driver stored in the database; and
managing digital assets stored in the registered third-party web service by selecting the Smart Drive and issuing commands through a web desktop user interface and an API layer in the web platform.
